(19) United States
(12) Patent Application Publication
(10) Pub. No.: US 2016/0061258 A1
(43) Pub. Date: Mar. 3, 2016

(54) NEEDLE BEARING WITH A CAGE AND A RETAINING TAB FORMED ON THE CAGE

(71) Applicant: Schaeffler Technologies AG & Co. KG, Herzogenaurach (DE)

(72) Inventors: Alexander Kern, Erlangen (DE); Lisa Dombos, Schwaig (DE); Herbert Rost, Herzogenaurach (DE)

(73) Assignee: SCHAEFFLER TECHNOLOGIES AG & CO. KG, Herzogenaurach (DE)

(21) Appl. No.: 14/719,502

(22) Filed: May 22, 2015

(30) Foreign Application Priority Data
Aug. 28, 2014 (DE) 102014217168.7

(51) Int. Cl. F16C 33/46; F16C 19/46

(52) U.S. Cl. CPC F16C 33/4605; F16C 19/463; F16C 33/4623

(57) ABSTRACT

A needle bearing (1) with at least one bearing shell (3) for needle-shaped roller bodies (5) and with a cage (4) for guiding the roller bodies (5), wherein a retaining tab (10) formed on the cage (4) interacts axially with the bearing shell (3) for securing the cage (4). Furthermore, a roller bearing assembly with a needle bearing of this type is provided, additionally with a thrust washer (15) for securing the cage (4) that interacts axially with the cage (4), supplementing the interaction of the retaining tab (10) with the bearing shell (3).

### INCORPORATION BY REFERENCE

The following documents are incorporated herein by reference as if fully set forth: German Patent Application No.: 102014217168.7, filed Aug. 28, 2014.

### BACKGROUND

The invention relates to a roller bearing, namely a needle bearing or needle roller bearing, with at least one bearing shell for needle-like roller bodies and with a cage for guiding the roller bodies.

Such roller bearings of this construction are known. As the roller bodies, needle-shaped rollers are provided, that is, cylindrical bodies with diameters that are relatively small compared to the cylinder length. These roller bodies are also designated, for example, as needles, needle roller bodies, rollers, or needle rollers. Such roller bearings have not only the typical roller bearing advantages, for example, simple lubrication or low friction, but also, due to the small roller body diameters, a large number of roller bodies and therefore typically a high load capacity. Another advantage of roller bearings with needle-like roller bodies is the relatively low requirements for installation space. Thus, such roller bearings are preferably used when a construction allows no bearing shell or only one bearing shell for the roller bearing, so that, for example, a shaft and/or a hub is/are formed as a bearing shell in one piece on its surface. In the present case, at least one bearing shell belonging to the roller bearing is provided.

Such roller bearings often have problems with respect to transport and installation of the roller bodies and the cage in a ready-to-install relative arrangement for assembly.

For example, from DE 101 23 965 A1 a needle bearing is known with a thin-walled outer ring shaped without cutting and a needle ring that is arranged therein and consists of a cage with needle bearings, as well as means that prevent the needle ring from moving out of the outer ring, wherein the outer ring is provided only on one side with a rim directed radially inward, while on the opposite rim-less side there is, at least at one circumferential position, at least one radially outward bent tab on which a corresponding projection of a circular-like thrust washer contacts, wherein the tab and the projection are connected to each other.

In other words, in the known prior art, in addition to the parts that realize roller bearing functions during operation, for example, the outer ring or the bearing shell, the cage and the bearing needles, additional parts are required, for example, a circular ring-type thrust washer. In addition, complicated geometry is necessary, for example, the tabs that are bent radially outward. If the thrust washer is intended only for transport and/or installation purposes, additional assembly and/or disassembly effort is also produced. The measures named above also require complicated production technology, additional weight, and increased costs.

### SUMMARY

Therefore, the objective of the present invention is to provide securing of the needle ring without additional parts. The invented solution should be structurally simple and/or economical. Furthermore, disadvantages from the prior art should be avoided or eliminated or at least reduced.

This objective is achieved according to the invention for a roller bearing according to the class in that a retaining tab formed on the cage interacts axially with the bearing shell for securing the cage. Because the retaining tab is formed on the cage itself, an additional part is not needed and weight and/or costs are saved.

Advantageous embodiments are described below and in the claims. The aspects specified there can also be claimed individually, independent from each other and from the main aspect.

It can be further provided that the bearing shell is a bearing inner ring. In this way, the roller bearing is suitable for use in an installation space with axially limited outer dimensions.

It can be further provided that the bearing shell is a bearing outer ring. In this way, the roller bearing is suitable for use in an installation space with axially limited inner dimensions.

It is economical, and thus advantageous, if the bearing shell is formed in one piece.

If the retaining tab is formed in one piece with the cage, one assembly step can be saved.

If the retaining tab interacts axially with a groove, notch, or bevel formed on the bearing shell, an interaction of the retaining tab with the bearing shell can be achieved with typical structural means. This produces overall an economical roller bearing.

The retaining tab can be formed on a ring section of the cage formed in the circumferential direction. This has the result that just the retaining tab itself slightly increases the mass moment of inertia of the roller bearing, while for connecting the cage to the retaining tab, a section typically already provided on the cage can be used. This saves weight and costs.

The retaining tab can be provided in the circumferential direction as a continuous or broken ring. Thus, a rotationally symmetric contour is provided on a basically rotationally symmetric body. This helps to save costs.

The retaining tab can likewise be formed as a segment in the circumferential direction. Thus, more weight and, due to the reduced use of materials, costs can be saved. Here it can be further provided that the retaining tab is formed as a plurality of segments. Advantageously, this is further refined in that the segments are divided equally into a plurality of segments in the circumferential direction. This allows an axial securing of the cage distributed in the circumferential direction on the bearing shell, wherein advantageously an imbalance is prevented. This has the advantage of smooth running of the roller bearings.

An optimized running contact behavior, and thus reduced friction during operation of the roller bearings, can be achieved if the retaining tab is formed on the roller body side at an angle to the axial direction, wherein the angle is less than 180°. Thus costs can be saved in operation. If this angle is less than approx. 178°, then the desired running contact behavior can be achieved with greater reliability. The reliability can be increased even more if the angle is less than approximately 135°. It is preferred if the angle is ≧90°, because in this way an undercut on the cage can be avoided. This has the advantage that a simple tool geometry is possible with only low costs.

Furthermore, two retaining tabs could be provided that secure the cage axially in two directions and in this way extend each other. If the cage is secured axially in two directions by retaining tabs, other axial securing means can be eliminated, so that the assembly expense and the costs are generally reduced even more.

Furthermore, a roller bearing assembly with a roller bearing/needle bearing as described above and with a thrust washer for securing the cage can be provided, wherein the thrust washer interacts axially with the cage, supplementing the interaction of the retaining tab with the bearing shell. In this way, it can be optionally provided that the thrust washer can be removed/is removed after assembly. This variant is suitable, for example, an assembly task required for the thrust washer plays only a subordinate role relative to an especially fixed axial securing device. As an example, a construction can be named in which the roller bearing is pressed in.

In other words: It should be prevented that a needle ring can slip during transport and/or during assembly by a bearing shell formed as an inner ring or as an outer ring. The needle ring should be secured axially on the inner ring or the outer ring so that slipping and/or loss is prevented. For this purpose, axial securing of the needle ring by a retaining tab is provided. The retaining tab can be provided, in particular, in segmented form and/or in ring form. The retaining tab can be shaped, in particular, radially, that is, in the direction toward the inner ring or toward the outer ring. The retaining tab should be formed on a cage. It is thus proposed to modify the needle ring and, in particular, the cage, by a retaining tab or in the form of a retaining tab. This retaining tab should be supported on the inner ring or on the outer ring and thus prevent the undesired axial slipping and/or the undesired axial loss of the needle ring.

Expressed in yet another way, the present invention relates to a roller bearing, more precisely, a needle ring and, in particular, a cage for guiding roller bodies. Such a needle ring can be used for supporting chain wheels, for example, for an intermediate gear device in an internal combustion engine. Previously, such a needle ring was secured, for example, by two thrust washers laterally contacting a shaft, for example, an intermediate gear shaft, against axial displacement during transport and/or assembly, for example, assembly of the intermediate gear device. Such thrust washers, however, represent additional parts that increase the assembly or disassembly effort and/or weight, for example, of the intermediate gear device. The thrust washers also cause additional costs. Therefore it is provided to realize the axial securing of the needle ring and, in particular, the cage, for example, on the intermediate gear shaft by a retaining tab formed on one end side or one each of two end sides of a cage and directed, preferably radially, for example, toward an intermediate gear shaft with a ring-shaped and/or segmented construction. The retaining tab should engage, for example, in an end-side bevel, for example, on the intermediate gear shaft. For example, the axial securing of the needle ring can alternatively also be realized on bearing holes of the chain gears by identical retaining tabs directed radially toward the chain gears on the cage of the needle ring.

### BRIEF DESCRIPTION OF THE DRAWINGS

The invention will be described below in more detail with the help of several embodiments. Shown are:

FIG. 1 a longitudinally sectioned representation of a roller bearing, namely a needle bearing, according to a first embodiment,

FIG. 2 an enlarged representation of the area marked with II in FIG. 1,

FIG. 3 a perspective, sectioned representation of the roller bearing of FIG. 1,

FIG. 4 an enlarged representation of the area marked with IV in FIG. 3,

FIG. 5 a representation of an end side of the roller bearing of FIG. 1,

FIG. 6 a perspective representation of the roller bearing of FIG. 1,

FIG. 7 a longitudinally sectioned representation of a roller bearing according to a second embodiment,

FIG. 8 an enlarged representation of the area marked with VIII in FIG. 7,

FIG. 9 a perspective representation of the roller bearing of FIG. 7,

FIG. 10 a longitudinally sectioned representation of a roller bearing according to a third embodiment,

FIG. 11 an enlarged representation of the area marked with XI in FIG. 10,

FIG. 12 a perspective, sectioned representation of the roller bearing of FIG. 10,

FIG. 13 an enlarged representation of the area marked with XIII in FIG. 12,

FIG. 14 a representation of an end side of the roller bearing of FIG. 10, and

FIG. 15 a perspective representation of the roller bearing of FIG. 10.

### DETAILED DESCRIPTION OF THE PREFERRED EMBODIMENTS

The figures are merely of a schematic nature and are used only for understanding the invention. Identical or comparable elements are provided with the same reference symbols. Features of one embodiment can also be included in the other embodiments. Thus they are interchangeable with each other.

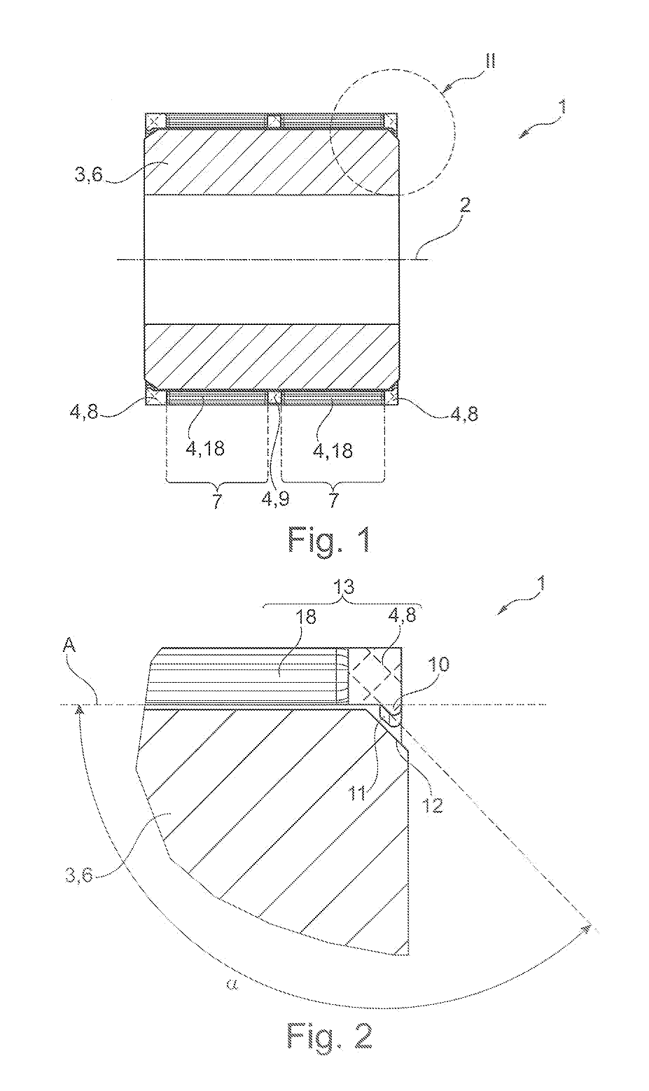

A roller bearing 1 according to a first embodiment will be explained below with reference to FIG. 1 to FIG. 6.

The roller bearing 1 is constructed essentially rotationally symmetric to a longitudinal axis 2. The roller bearing 1 has a bearing shell 3 and a cage 4. The cage 4 is used for securing and guiding the roller bodies. The roller bodies are not shown in FIGS. 1 to 6, but the roller body receptacles 18 formed in or on the cage 4 are shown.

In the first embodiment, the bearing shell 3 is a bearing inner ring 6. In the first embodiment, the roller bearing 1 is a two-row roller bearing, that is, two rows 7 of roller body receptacles 18 with roller bodies held therein are arranged one next to the other in the axial direction. Here, the cage 4 has two axially end-side ring sections 8 and has an intermediate ring section 9 between the rows 7. The ring sections 8, 9 are formed in the circumferential direction, that is, about the longitudinal axis 2. In particular, in the first embodiment, the ring sections 8, 9 are formed continuous in the circumferential direction. In particular, neither the two-row construction of the roller bearing 1, nor the presence of the intermediate ring section 9, nor the construction of the ring sections 8, 9 formed continuous in the circumferential direction are understood in a restrictive sense.

In FIG. 2, which shows the area marked with II in FIG. 1 in an enlarged representation, an axially end-side ring section 8 can be seen particularly well. A retaining tab 10 is formed on this ring section 8. The retaining tab 10 extends from the ring section 8 or the cage 4 inward in the radial direction. In other words, the retaining tab 10 extends from the ring section 8 or the cage 4 outward in the direction of the bearing shell 3 formed as the bearing inner ring 6. The radial specification here refers to the longitudinal axis 2.

In FIG. 2, an axial direction A is shown with a dashed line. The axial direction A is parallel to the longitudinal axis 2. A flank 11 of the retaining tab 10 points in the axial direction essentially toward the roller bodies or the roller body receptacles 18. The flank 11 is thus formed on the roller body side on the retaining tab 10. The flank 11 is formed at an angle α to the axial direction A. Thus, the retaining tab 10 is formed on the roller body side at the angle α in the axial direction A. In the present case, the angle α equals approximately 135°. It should be noted that the angle α should preferably be less than 180°. It is desirable if the angle α is less than 178°. The angle α should also be ≧90°. In other words, the angle α should be between 90°, inclusive, and 180°, exclusive.

A bevel 12 is formed on the bearing shell 3. Here, the retaining tab 10 is formed so that this is provided axially and radially in the area of the bevel 12. If a needle ring 13 that includes the cage 4 and the roller body is now loaded with a force in the axial direction from the end-side ring section 8 to the roller bodies (toward the left in FIG. 2), then the flank 11 is brought into contact with the bevel 12. Thus, a slipping of the needle ring 13 in the axial direction is prevented by an interaction of the bevel 12 and the retaining tab 10. Thus, the retaining tab 10 and the bevel 12 of the bearing shell 3 interact axially for securing the cage 4.

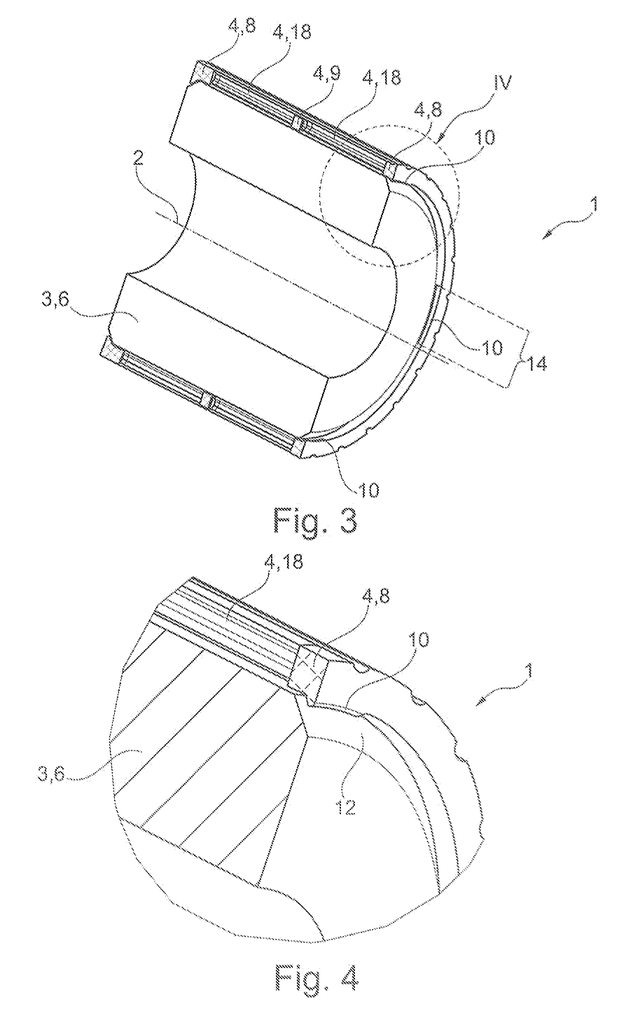

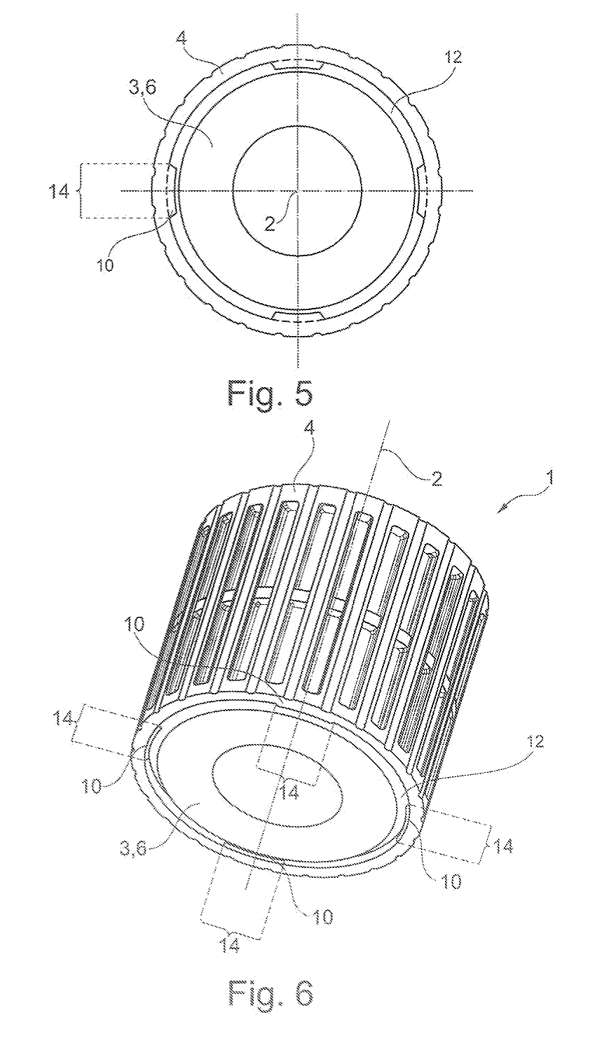

As can be seen from the perspective representation of FIGS. 3 and 4, the retaining tab 10 is not formed continuous in the circumferential direction, but instead is formed by four segments 14. The segments 14 are divided equally in the circumferential direction. Thus no imbalance is generated by the segments 14. The equal division of the segments 14 is also made clear from the end side view of FIG. 5 and also the perspective view of FIG. 6.

From the representation in FIGS. 1 and 3 it is visible that, in the first embodiment, there are two retaining tabs 10 that secure the cage 4 axially in two direction and in this way extend each other. Here, the flanks 11 of the retaining tabs 10 point axially at least partially toward each other. In interaction with two bevels 12 formed axially on the end side on the bearing shell 3, a slipping of the cage 4 (beyond a tolerable degree) is prevented.

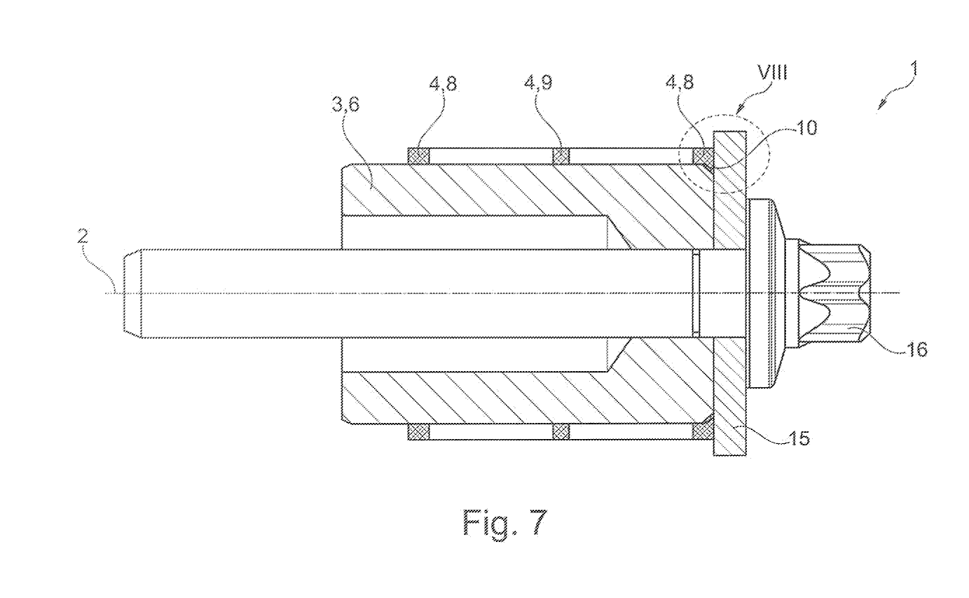

A second embodiment of a roller bearing 1 according to the invention is described with reference to FIGS. 7 to 9. Comparable elements are provided with the same reference symbols and are therefore not described again. As can be seen from the sectional representation in FIG. 7, the roller bearing 1 according to the second embodiment is also provided with a bearing shell 3 formed as a bearing inner ring 6 and with a cage 4 with roller bearing receptacles 18. In contrast with the first embodiment, however, in the second embodiment, a retaining tab 10 is provided only on one end-side ring section 8.

On the sides of the retaining tab 10, a thrust washer 15 is provided axially next to the cage 4. The thrust washer 15 is attached to the bearing shell 3 by a screw 16.

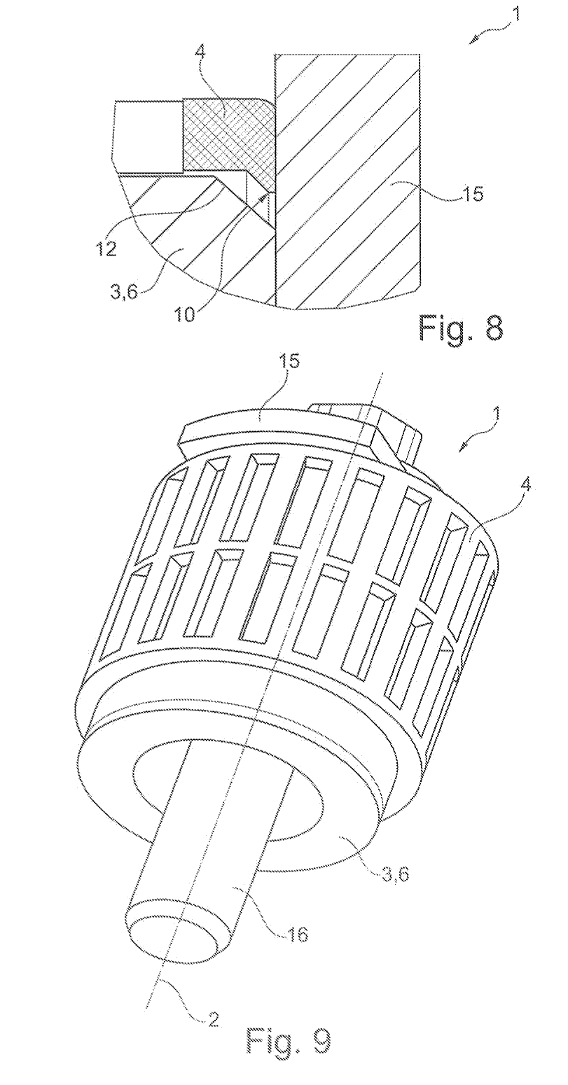

FIG. 8 shows an enlarged representation of the area marked with VIII in FIG. 7. As is visible from FIG. 8, a bevel 12 is formed on the bearing shell 3. The retaining tab 10 again interacts axially with the bearing shell 3 or with the bevel 12 of the bearing shell 3. In this way it is prevented that the cage 4 can slip in the axial direction from the end-side ring section 8 relative to the roller bodies (toward the left in FIG. 7). Consequently, the retaining tab 10 and the bearing shell 3 interact for securing the cage 4 axially. The thrust washer 15 prevents the cage 4 from being able to be displaced in the other axial direction. The thrust washer 15 represents a transport securing device that must be removed, for example, after successful assembly.

From the representation of FIG. 8 it is visible that the thrust washer 15 does not squeeze the retaining tab 10 against the bevel 12. This is preferred but should not be understood in a restrictive sense.

FIG. 9 again shows, in a perspective representation, the relative arrangement of the screw 16, thrust washer 15, cage 4, and bearing shell 3.

Reference is also made to the description of the first embodiment.

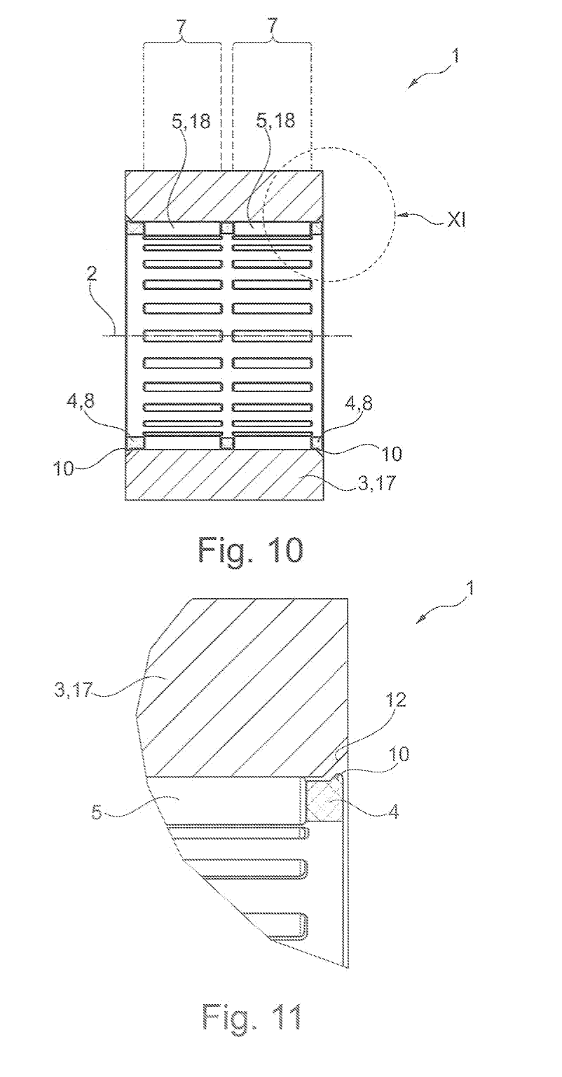

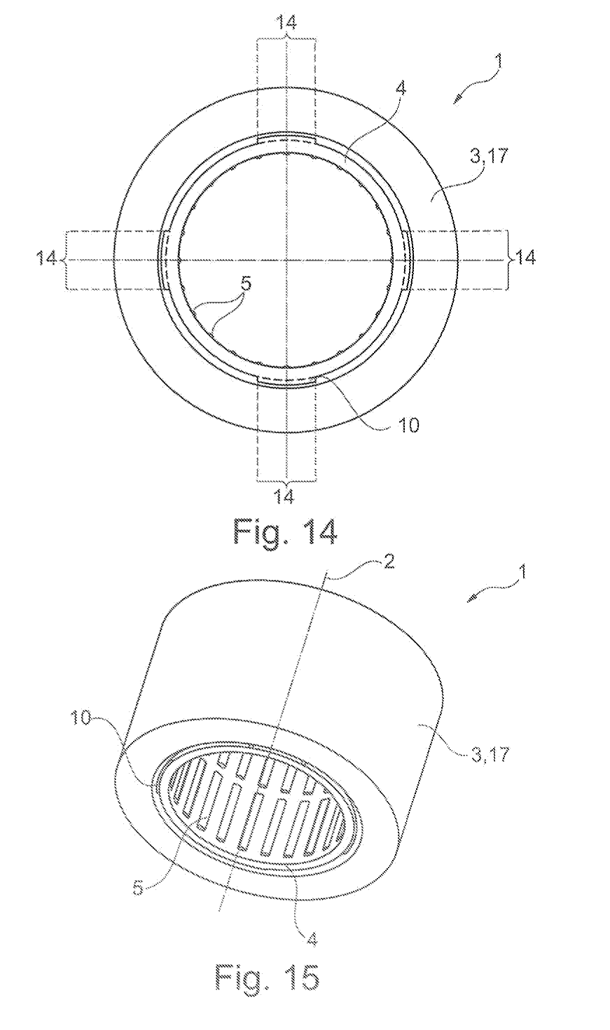

With reference to FIG. 10 to FIG. 15, a roller bearing 1 according to a third embodiment of the invention is described. Comparable elements are again provided with identical reference symbols and therefore will not be described again.

In the third embodiment, the bearing shell 3 is formed as bearing outer ring 17. The roller bearing 1 according to the third embodiment is also formed as a two-row roller bearing.

From the enlarged representation in FIG. 11, which shows the area marked with XI in FIG. 10, the position of a retaining tab 10 is visible. The retaining tab 10 is formed extending radially outward in the third embodiment. In other words, the retaining tab 10 in the third embodiment points in the direction of the bearing shell 3 formed as the bearing outer ring 17. A bevel 12 is formed on the bearing shell 3 of the third embodiment. Here, the retaining tab 10 is provided axially and radially in the area of the bevel 12. Thus, the retaining tab 10 and the bearing shell 3 interact axially for securing the cage.

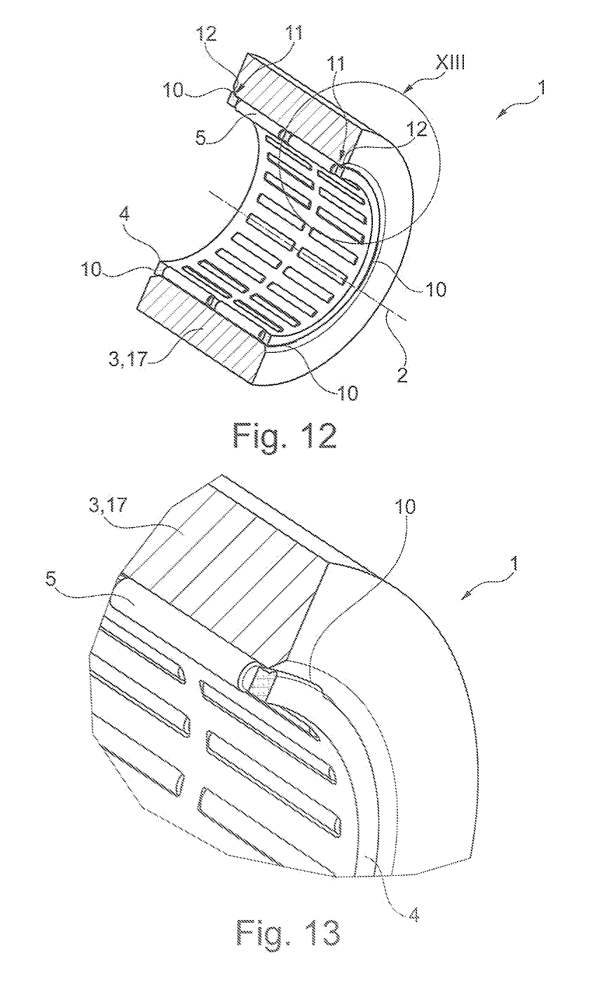

From the representation in FIG. 12 to FIG. 15 it is visible that also in the third embodiment, the retaining tab 10 is formed as four segments 14 divided equally in the circumferential direction.

From the representations in FIGS. 10 and 12 it is also visible in the third embodiment that two retaining tabs 10 are provided that secure the cage 4 axially in two directions and in this way extend each other. Here, the flanks 11 of the retaining tabs 10 point axially at least partially toward each other. The cage 4 is prevented from slipping (greater than a tolerable degree) through interaction with two axially end side bevels 12 formed on the bearing shell 3.

The representations of FIGS. 10 to 15 further show how roller bodies 5 are held in the roller body receptacles 18, namely so that the roller bodies 5 extend radially inward and outward past the cage 4. Thus, in operation, the cage 4 does not rub against the bearing shell 3.

Reference is also made to the description of the first and second embodiments.

List of Reference Symbols

| | |
|---|---|
| 1 | Roller bearing |
| 2 | Longitudinal axis |
| 3 | Bearing shell |
| 4 | Cage |
| 5 | Roller body |
| 6 | Bearing inner ring |
| 7 | Row |
| 8 | End-side ring section |
| 9 | Intermediate ring section |
| 10 | Retaining tab |
| 11 | Flank |
| 12 | Bevel |
| 13 | Needle ring |
| 14 | Segment |
| 15 | Thrust washer |
| 16 | Screw |
| 17 | Bearing outer ring |
| 18 | Roller body receptacle |
| A | Axial direction |
| α | Angle |

1. A needle bearing comprising at least one bearing shell, needle-shaped roller bodies, a cage for guiding the roller bodies on the at least one bearing shell, and a retaining tab formed on the cage interacts axially with the bearing shell for securing the cage.

2. The needle bearing according to claim 1, wherein the bearing shell is a bearing inner ring or a bearing outer ring.

3. The needle bearing according to claim 1, wherein the bearing shell is formed in one piece.

4. The needle bearing according to claim 1, wherein the retaining tab is formed in one piece with the cage.

5. The needle bearing according to claim 1, wherein the retaining tab interacts axially with a groove or bevel formed on the bearing shell.

6. The needle bearing according to claim 1, wherein the retaining tab is formed on a ring section of the cage formed in a circumferential direction.

7. The needle bearing according to claim 1, wherein the retaining tab is formed in a circumferential direction as a peripheral ring or as a segment or as a plurality of segments.

8. The needle bearing according to claim 1, wherein the retaining tab is formed on a side of the cage at an angle (α) to the axial direction, and the angle (α) is less than 180°.

9. The needle bearing according to claim 1, wherein two of the retaining tabs are provided that secure the cage axially in two directions.

10. A roller bearing assembly comprising a needle bearing according to claim 1, and a thrust washer for securing the cage that interacts axially with the cage, that supplements an interaction of the retaining tab with the bearing shell.
